(19) United States
(12) Patent Application Publication
(10) Pub. No.: US 2006/0142048 A1
(43) Pub. Date: Jun. 29, 2006

(54) Apparatus and methods for improved management of server devices

(76) Inventors: Tomm V. Aldridge, Olympia, WA (US); Patrick Gelsinger, Beaverton, OR (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/024,893

(22) Filed: Dec. 29, 2004

(51) Int. Cl. H04Q 7/20; H04M 1/00

(52) U.S. Cl. 455/550.1

(57) ABSTRACT

Apparatus, systems and methods for improved management of devices, one embodiment of which includes a plurality of system components, at least one of which includes an antenna coupled to the system component to transmit signals containing information related to at least one performance aspect of the system component. Other embodiments include a management entity to receive the signals and analyze the information contained therein and to provide control signals meant to cause an alteration in at least one performance aspect of a system component.

### TECHNICAL FIELD

Various embodiments described herein relate to network and management communications, generally, including systems and apparatus for improved communication between system sub-components and management devices.

### BACKGROUND

Enterprise datacenters are composed of hundreds and sometimes thousands of distinct compute, networking, storage and communications nodes which are characteristically housed in equipment racks that are interconnected with network, power and storage cables. Servers and other rack mounted devices typically have internal monitor and control points that are used to report on the health of the system and to receive command information. Additionally complete data that would allow adequate monitoring and control require communications with numerous other sensors in the enterprise datacenters. Improved systems for the collection of data and control of system elements are needed.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a block diagram of a system of devices according to embodiments of the present invention;

FIG. 2A is a high level block diagram of a device, such as depicted in FIG. 1, according to embodiments of the present invention;

FIG. 2B is a high level block diagram of a device, such as depicted in FIG. 1, according to embodiments of the present invention;

FIG. 3 is a high level block diagram of a device, such as depicted in FIG. 1, according to embodiments of the present invention;

FIG. 4 is a high level block diagram of a system of interconnected devices, such depicted in FIG. 1, according to embodiments of the present invention;

FIG. 5 is a high level block diagram of a system of devices, such as depicted in FIG. 2A, according to embodiments of the present invention; and

FIG. 6 is a flowchart of a high level method to be used by a device as contemplated by FIG. 4 according to embodiments of the present invention.

### DETAILED DESCRIPTION

In the following detailed description of embodiments of the invention, reference is made to the accompanying drawings which form a part hereof, and in which is shown by way of illustration specific preferred embodiments in which the subject matter may be practiced. These embodiments are described in sufficient detail to enable those skilled in the art to practice them, and it is to be understood that other embodiments may be utilized and that logical, mechanical, and electrical changes may be made without departing from the spirit and scope of the present disclosure. Such embodiments of the inventive subject matter may be referred to, individually and/or collectively, herein by the term “invention” merely for convenience and without intending to voluntarily limit the scope of this application to any single invention or inventive concept if more than one is in fact disclosed. The following detailed description is, therefore, not to be taken in a limiting sense, and the scope of the present disclosure is defined only by the appended claims.

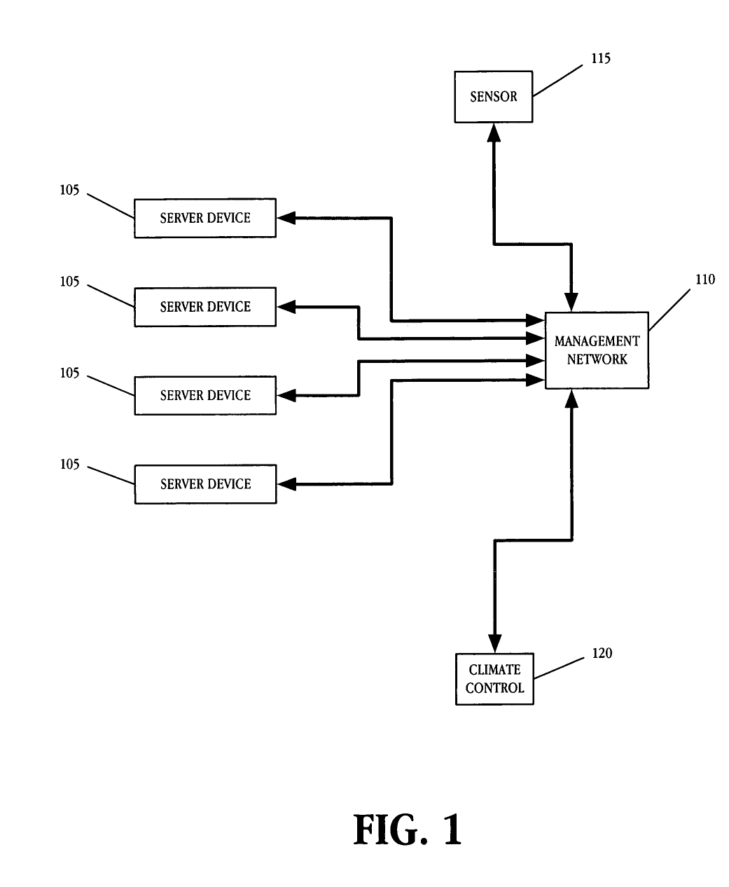

FIG. 1 is a block diagram of a system of devices according to embodiments of the present invention. In an embodiment, server devices 105 are communicatively coupled a management network 110. In another embodiment, the management network 110 is additionally communicatively coupled to at least one sensor 115 and at least one climate control device 120. The management network 105 receives signals from the server devices 105 relating to performance aspects. In an embodiment, performance aspects include, without limitation, power consumption, processor performance, storage capacity, temperature and the like. Though the term server device is used, this is not meant to be limiting in any manner, and server devices, for the purpose of the present application, include any device that is configured to provide services to other devices.

In an embodiment, the management network 110 is configured to receive signals from the server devices 105 relating to performance aspects and to analyze those signals to determine the relative health of each of the server devices 105. In another embodiment, the management network 110 is configured to analyze those signals to determine the relative health of all server devices 105. In a further embodiment, the management network 110 is further configured to send control signals to the server devices 105. Control signals include instructions configured to cause a change in the operation of at least one component of the server device.

In an embodiment, the sensors 115 are configured to measure environmental data related to the environment in which the server devices 105 are operating. Environmental data may include, without limitation, air temperature, humidity levels, air-flow and the like. In an embodiment, the sensors 115 transmit signals to the management network 110 in which the signals contain environmental data. In a further embodiment, the management network 110 analyzes those signals in addition to signals received from the server devices 105 to determine the relative health of the environment in which the server devices 105 are operating in.

In an embodiment, climate control devices 120 are configured to alter the environment in which the server devices 105 are operating by causing a change to at least one measurement of environmental data. Methods of individual climate control devices to alter at least one measurement of environmental data are well known to those skilled in the art and outside the scope of the present application. In an embodiment, the management network 110 receives signals from the server devices 105 and the sensors 115. The management network 110 analyzes those signals to determine if the environment needs to be altered. The management network 110 is configured to send command signals to the climate control devices 120 to alter at least one performance aspect of the climate control device 120. In an embodiment, such alteration is to cause a change in at least one aspect of the environmental data. In a further embodiment, the management network 110 additionally receives signals from the climate control devices 120 relating to performance aspects. Performance aspects of a climate control device 120 include, without limitation, fan speed, fan blade pitch, airflow, energy requirements, heating efficiency, cooling efficiency and the like. For example, the management network 110 receives signals containing performance aspects of two fans, one of which is unable to operate at full speed. The management network 110 can alter the fan speed of the other fan to compensate for the underperforming fan.

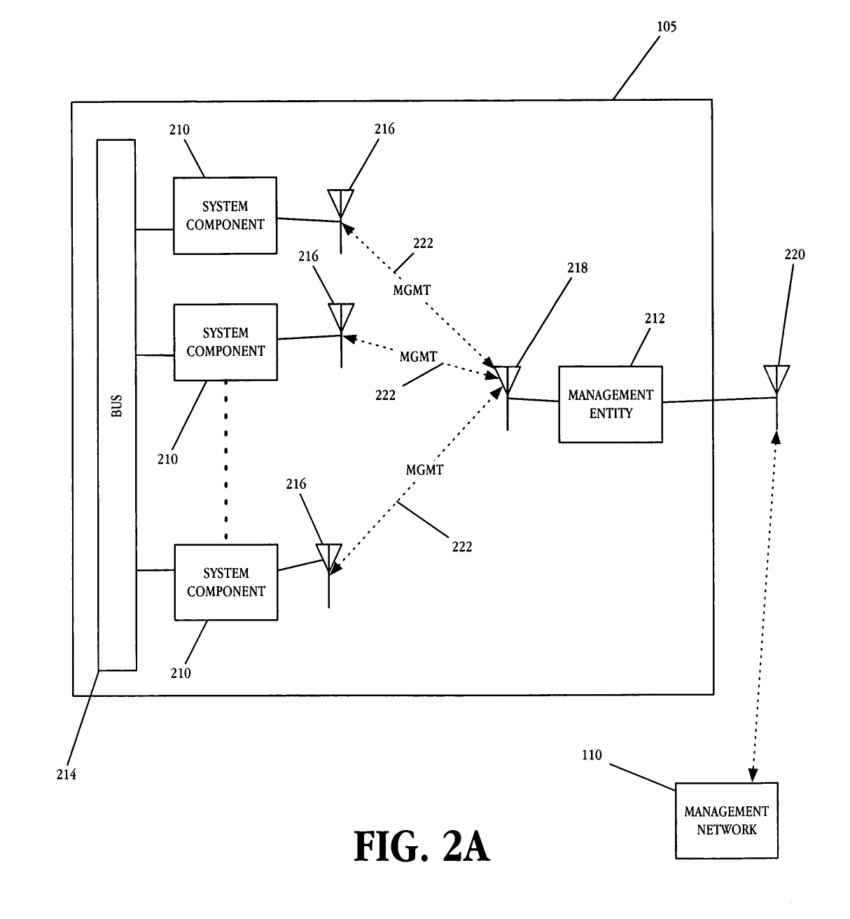

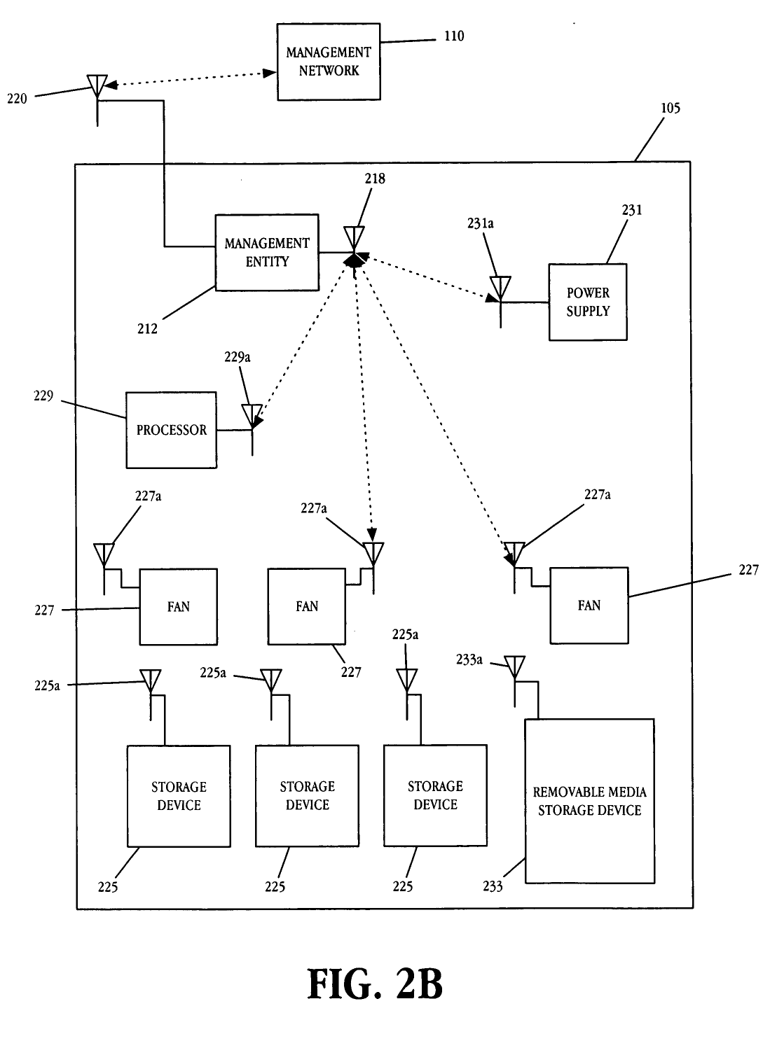

FIG. 2A is a high level block diagram of a device, such as the device depicted in FIG. 1, according to embodiments of the present invention. In an embodiment the device is a server device 105 as contemplated in FIG. 1. The server device 105 comprises a plurality of system components 210, a management entity 212 and a bus 214.

In an embodiment, the plurality of system components are individually coupled to an antenna 216. The antenna 216 receives signals from the system component 210 relating to at least one performance aspect of that system component 210 and is configured to transmit that signal to a system-side antenna 218 coupled to the management entity 212. In an embodiment, the signal transmitted to the system-side antenna 218 of the management entity 212 is a wireless signal transmitted to the system-side antenna 218. Wireless signals may include, without limitation: Global System for Mobile Communications (GSM); General Packet Radio Service (GPRS); Code Division Multiple Access (CDMA); Time Division Multiple Access (TDMA); IEEE 802.11 standard signals, IEEE std. 802.11-1999, published 1999 and later versions (hereinafter IEEE 802.11 standard); IEEE 802.16 standard signals, IEEE std. 802.16-2001, published 2001 and later versions (hereinafter IEEE 802.16 standard); IEEE 802.15 standard signals, IEEE std. 802.15.1-2003, published 2003, IEEE 802.15.2-2003, published 2003, IEEE 802.15.3-2003, published 2003 and later versions (hereinafter IEEE 802.15 standard); Wide Band CDMA (WCDMA); High Speed Downlink Packet Access (HSDPA); or Ultra WideBand (UWB). Though specific types of wireless signals are listed, for the embodiments herein it is to be appreciated that any signal that passes between two devices without a wire is considered to be a wireless signal.

Though depicted as being physically separate from the system component 210, the antenna 216 may be an integral part of the system component 210. For example, in the case of a processor, the capabilities of an antenna may be fabricated directly into the processor package itself. One example of such an implementation is wireless-internet-on-a-chip, in which the key components of cellular phones and computers are integrated into a single chip. This example is not meant to be limiting in any way, and any integration of the functionality of a device configured to transmit and receive wireless signals into a system component is considered to be within the scope of the present application.

In an embodiment, the management entity 212 is coupled to a system-side antenna 218 and a management-side antenna 220. The system-wide antenna 218 is configured to receive wireless signals from the antenna 216 coupled to the system component 210. In an embodiment, the wireless signal is a wireless management signal 222. In an embodiment, the wireless management signal 222 contains information related to at least one performance aspect of the system component 210. Such signals are called performance signals. In another embodiment, the wireless management signal 222 contains information related to the control, or control signals, of the system component 210. Control includes any direction from the management network meant to cause an alteration in at least one performance aspect of the system component. Though depicted and described as a system-wide antenna 218 and a management-side antenna 220, it will be understood that the functionality of both may be combined in a single antenna.

In an embodiment, the management entity 212 is configured to receive performance signals from the system components 210 and analyze those signals to determine the relative health of the server device 105. In another embodiment, the management entity 212 may be further configured to send control signals to the system components 210 in order to alter performance aspects of the system components 210 such that the relative health of the server 105 device may be affected.

In an embodiment, one or more system components 210 are coupled to a bus 214. The bus 214 is configured to at least pass control signals which instruct the one or more system components 210 coupled to it to read/write data, provide address locations detailing where data is to be read from/written to, and provide a channel over which the data is transferred. For the purposes of the present application, signals transmitted via the bus 214 between the one or more system components 210 to accomplish one or all of these functions are bus signals. In an embodiment, the bus 214 is further configured to supply power to the one or more system components. The bus 214 may represent one or more busses, e.g., USB (Universal Serial Bus), FireWire, PCI, ISA (Industry Standard Architecture), X-Bus, EISA (Extended Industry Standard Architecture), or any other appropriate bus and/or bridge (also called a bus controller).

In an embodiment, the one or more system components 210 of the server device 105 are configured to transmit performance signals to the system-side antenna 218 of the management entity 212 and to receive control signals from the system-side antenna 218. In a further embodiment, the one or more system components 210 are configured to transmit and receive bus signals through the bus 214.

In an embodiment, management entity 212 of the server device is operably coupled to the management-side antenna 220. The management-side antenna 220 may include one or more of a patch, omni-directional, beam, monopole, dipole, and rhombic antenna, among others.

FIG. 2B is a high level block diagram of a device, such as the device depicted in FIG. 1, according to embodiments of the present invention. In an embodiment the device is a server device 105 as contemplated in FIG. 1 and also discussed with respect to FIG. 2A. FIG. 2B is one example of a server device 105 as depicted in FIG. 2A. The server device 105 comprises one or more storage devices 225 coupled to one or more antennas 225a, one or more fans 227 coupled to one or more antennas 227a, one or more processors 229 coupled to one or more antennas 229a, one or more power supplies 231 coupled to one or more antennas 231a and a management entity 212. The management entity 212 is further coupled to a system-side antenna 218 and a management-side antenna 220. As discussed above, the system-side antenna 218 and management-side antenna 220 may be combined into a single antenna coupled to the management entity 212. In a further embodiment, the server device 105 comprises a removable storage device 233 coupled to one or more antennas 233a.

In an embodiment, each of the antennas coupled to a system component is configured to receive a performance signal from the system component and transmit a wireless performance signal to the system-side antenna 218 of the management entity 212. In another embodiment, the system-side antenna 218 is configured to receive control signals from the management entity 212 and to transmit a wireless control signal to the appropriate system component. For instance, if the management entity 212 determined that operation of one or more fans 227 were required to reduce the operating temperature of the server device 105, the management entity 212 would cause a control signal to be sent to the one or more fan 227. In such an example, the control signal would be first sent to the system-side antenna 218 which would then wirelessly transmit the control signal to the antenna 227a coupled to the one or more fan 227.

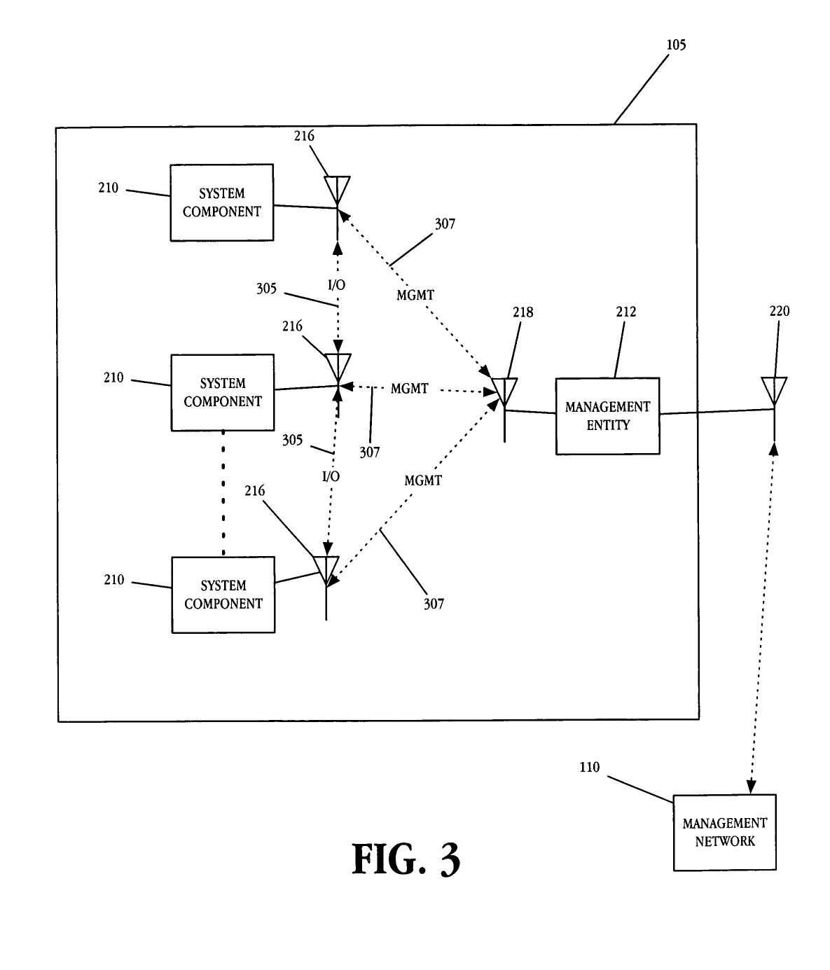

FIG. 3 is a high level block diagram of a device, such as the device depicted in FIG. 1, according to embodiments of the present invention. In an embodiment the device is a server device 105 as contemplated in FIG. 1. FIG. 3 is similar to FIG. 2A with an additional wireless data path between the antennas 216 coupled to the system components 210. In an embodiment, the antennas 216 coupled to the system components 210 are configured to send and receive bus signals 305 in addition to management signals 307. Management signals 307 include performance signals and control signals as described above. In an embodiment, the bus signals 305 perform substantially the same function as the bus signals described with respect to FIG. 2A.

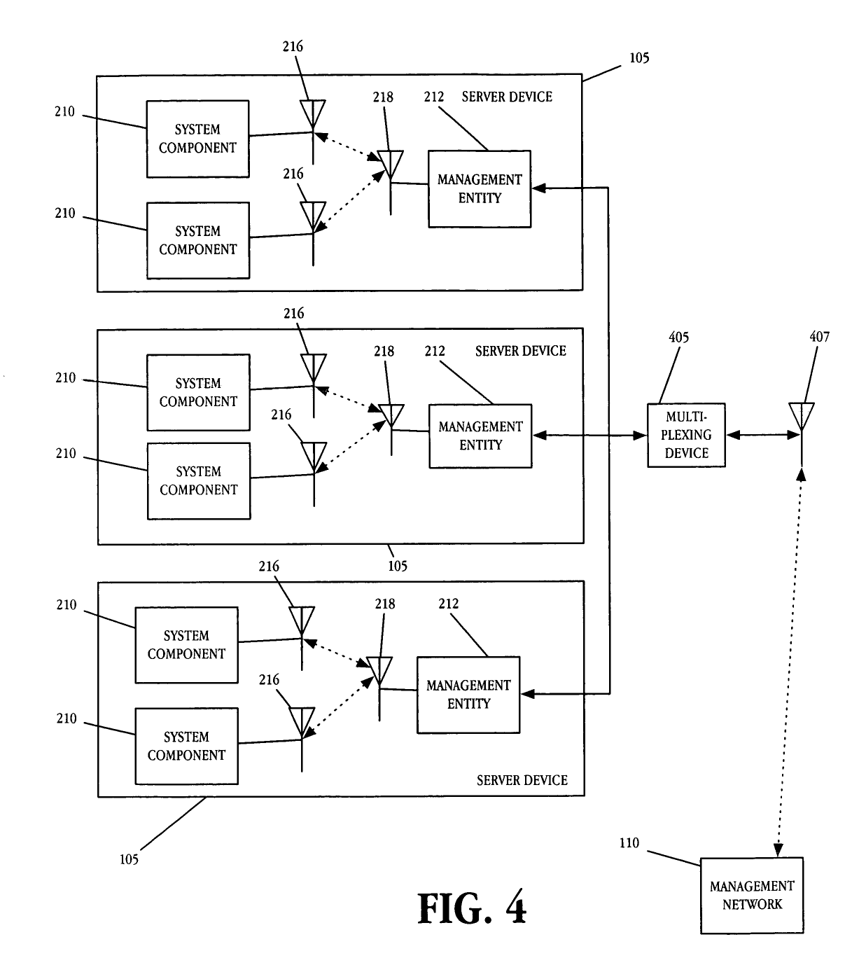

FIG. 4 is a high level block diagram of a system of interconnected devices, such as those depicted in FIG. 1, according to embodiments of the present invention. In an embodiment the interconnected devices are server devices 105 as contemplated in FIG. 1. The system comprises one or more server devices 105 communicatively coupled to a multiplexing device 405. In an embodiment, the multiplexing device is coupled to an antenna 407.

In an embodiment, several server devices 105 are located in proximity to each other. An example of such an arrangement may include, without limitation, a server rack as is well known in the art. In an embodiment, each of the several server devices 105 are configured similarly to the server device 105 depicted in FIG. 2A. In another embodiment, the server devices 105 are separately configured. However, in such an example, each server device 105 would comprise at least a management entity 212 receiving performance signals from at least one system component 210 and to send control signals to at least one system component 210.

In an embodiment, the management entities 212 of the several server devices 105 are communicatively coupled to a single multiplexing device 405. This may include, without limitation, a wireless connection between the management entity 212 and the multiplexing device 405 and a wired connection between the management entity 212 and the multiplexing device 405. In a further embodiment, the management entities 212 of at least one or more of the several server devices 105 are communicatively coupled to a single multiplexing device 405. The management signals from the management entity 212 of each individual server device 105 are received by the multiplexing device 405 and combined into a single signal 409 which is transmitted wirelessly by the antenna 407 coupled to the multiplexing device 405.

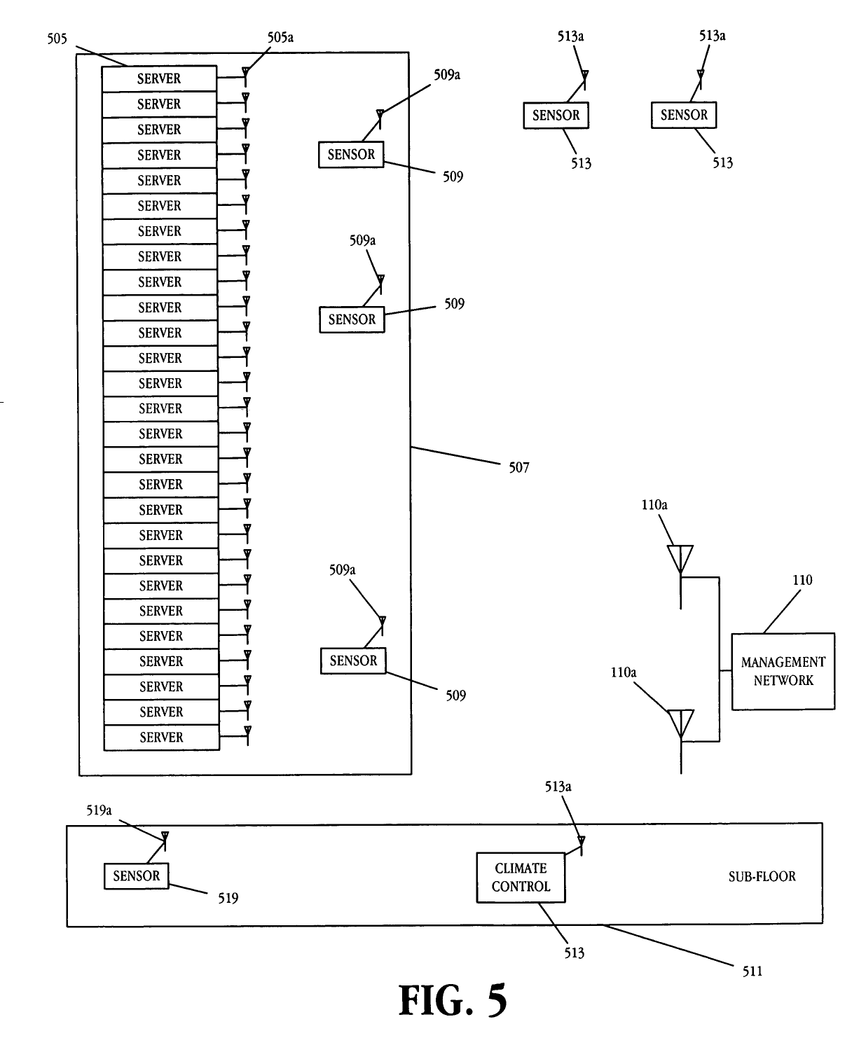

FIG. 5 is a high level block diagram of a system of devices, such as those depicted in FIG. 2A, according to embodiments of the present invention. In an embodiment, the system comprises a plurality of server devices 505, a server rack 507 housing the plurality of server devices 505, at least one rack sensor 509, a sub-floor 511, at least one room sensor 513 and a management network 110.

In an embodiment, several server devices 105 are contained in a single enclosure, such as the server rack 507. Each of the several server devices 105 is configured similarly to the server device 105 discussed above with respect to FIG. 2A. The server rack 507 also includes at least one rack sensor 509. The rack sensor 509 is coupled to an antenna 509a which is configured to transmit a wireless signal to at least one antenna 110a coupled to the management network. In an alternate embodiment, the antenna 110a is a wireless access point that is further communicatively coupled to the management network 110. In an embodiment, the rack sensor 509 is configured to measure at least one aspect of environmental data related to the server rack 507. Aspects of the environment environmental data related to the server rack 507 include, without limitation, temperature, electrical power, humidity, air-flow and the like.

In an embodiment, all the server devices 505 in the server rack 507 are coupled to a single multiplexing device, such as described above with respect to FIG. 4. In another embodiment, all of the server devices 505 are divided into substantially equal groups of server devices 505, with each group coupled to a single multiplexing device, such as described above with respect to FIG. 4. In such examples, the multiplexing device receives management signals from the management entities from the server devices 505, combines the signals into a single signal and transmits it wirelessly to the antenna 110a communicatively coupled to the management network 110.

In an embodiment, the rack server 507 is located in a room, the room additionally containing at least one room sensor 513 and a sub-floor 511. In an embodiment, the sub-floor 511 comprises at least one floor sensor 519, at least one climate control device 521. Each of the at least one floor sensor 519 and climate control device 521 are coupled to an antenna configured to transmit wireless signals to a management network 110. In an alternate embodiment, the climate control device 521 is external to the sub-floor 511. Climate control device 521 may include, without limitation, air conditioner, fans, and the like.

In an embodiment, the management network 110 is configured to receive wireless signals through at least one antenna 110a communicatively coupled to the management network 110 and from the antenna coupled to at least one of the following: at least one server device 105, at least one rack sensor 110, at least one room sensor 513, at least one floor sensor 519 and at least one climate control device 521. In an embodiment, the wireless signals contain performance information relating to which the device the antenna is coupled. In another embodiment, the management network 110 is further configured to send signals. In such an example, these signals are configured to cause the device to alter at least one performance aspect.

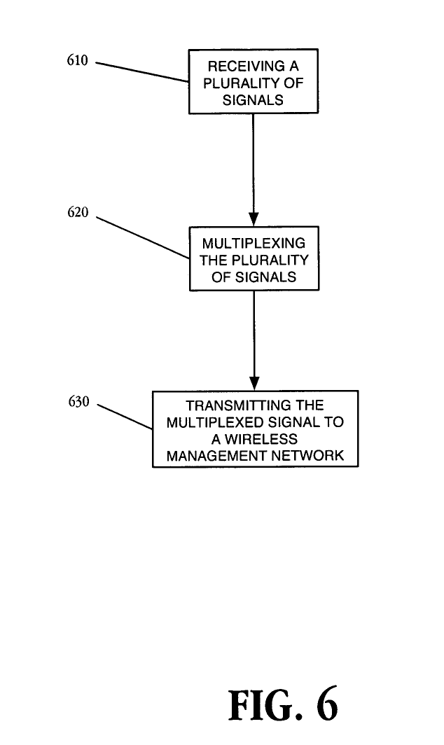

FIG. 6 is a flowchart of a high level method to be used by a device as contemplated by FIG. 4 according to embodiments of the present invention. At block 610a multiplexing device 405, such as that described with respect to FIG. 4 receives a plurality of signals from the management entities 212 from at least one server device 105. At block 620 the multiplexing device 405 combines those signals into a single multiplexed signal and transmits the multiplexed signal to a management network. Methods of multiplexing signals are well known in the art and need not be discussed further here. In an embodiment, the multiplexed signal is transmitted as a wireless signal to the management network 110 at block 620. Such an arrangement is advantageous as full-sized server racks are typically 42 U in size, accommodating as many as 42 single U server devices. A U is a standard measure of the height of a rack mounted device as is well known in the art. A 1 U device is approximately 1¾ inches high. A single wireless management signal from a multiplexing device coupled to the 42 single U server devices is more efficient than 42 separate wireless management signals from each of those server devices.

In a further embodiment, the multiplexing device 405 receives a single wireless control signal from the management network. The multiplexing device de-multiplexes the signal and directs the control signal to the appropriate management entity 212 of the appropriate server device 105.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments of the invention. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

What is claimed is:

1. Apparatus, comprising:
a plurality of system components, wherein at least one of the plurality of system components is coupled to an antenna; and
a management entity, wherein the management entity includes a system-side antenna coupled to the management entity to receive wireless signals from the antenna of the at least one of the plurality of system components.

2. The apparatus of claim 1, further comprising:
an external management network to receive a signal sent from the management entity.

3. The apparatus of claim 2, wherein the signal is a wireless signal.

4. The apparatus of claim 2, wherein the management entity is to receive a wireless signal from the external management network.

5. The apparatus of claim 1, wherein the antenna of the at least one of the plurality of system components is integral to the at least one of the plurality of system components to send performance signals and to receive control signals.

6. The apparatus of claim 2, wherein the management entity is to control at least one performance aspect of at least one of the plurality of system components.

7. The apparatus of claim 2, further comprising:
a bus coupled to the plurality of system components configured to send and receive bus signals from the plurality of system components.

8. Apparatus comprising:
a plurality of server devices, wherein at least one of the plurality of server devices includes at least one system component, wherein the at least one system component includes an integral antenna to transmit information regarding at least one performance aspect of the at least one system component; and a management entity to receive performance signals from the at least one system component and to transmit control signals to the at least one system component; and
at least one sensor, wherein the at least one sensor includes an antenna coupled to the at least one sensor to send and receive a signal.

9. The apparatus of claim 8, further comprising:
a wireless access point to receive a plurality of wireless signals, wherein the plurality of wireless signals includes at least one of the following:
a signal from the management entity; and
the signal from the at least one sensor.

10. The apparatus of claim 9, further comprising:
a management network communicatively coupled to the wireless access point.

11. The apparatus of claim 10, wherein the management network is to receive signals, analyze the received signals and transmit signals configured to cause an alteration of at least one performance aspect of at least one of the following:
at least one of the plurality of server devices;
the at least one sensor; and
at least one climate control device.

12. The apparatus of claim 8, wherein the plurality of computing devices includes a plurality of rack-mounted servers.

13. The apparatus of claim 8, wherein the at least one sensor includes at least one equipment sensor.

14. The apparatus of claim 8, further comprising:
at least one multiplexing device coupled to the management entities of the plurality of server devices to receive a plurality of signals from the management entities and to combine the plurality of signals into a single signal and wirelessly transmit the single signal.

15. The apparatus of claim 14, further comprising:
a management network communicatively coupled to the wireless access point.

16. The apparatus of claim 15, wherein the multiplexing device is to receive signals from the management entities and send a single wireless signal to the management network.

17. A method, comprising:
receiving a plurality of signals from a plurality of management entities coupled to a plurality of system components, at least one of which includes an antenna to transmit a performance related signal to a system-side antenna coupled to the management entity;
multiplexing the plurality of signals; and
transmitting the multiplexed signal to a management network.

18. The method of claim 17, further comprising:
analyzing the multiplexed signal; and
determining the relative health of the plurality of system components based on the analyzed multiplexed signal.

19. The method of claim 17, further comprising:
receiving a signal from a management network;
demultiplexing the signal into a plurality of signals, at least one of which is addressed to at least one of the plurality of management entities; and
sending the plurality of signals to the at least one of the plurality of management entities.

20. A machine readable medium having machine executable instructions contained therein, which when executed perform the following operations:
receiving a plurality of signals from a plurality of management entities coupled to a plurality of system components, at least one of which includes an antenna to transmit a performance related signal to a system-side antenna coupled to the management entity;
multiplexing the plurality of signals; and
transmitting the multiplexed signal to a management network.

21. The machine readable medium of claim 20, further comprising:
analyzing the multiplexed signal; and
determining the relative health of the plurality of system components based on the analyzed multiplexed signal.

22. The machine readable medium of claim 20, further comprising:
receiving a signal from a management network;
demultiplexing the signal into a plurality of signals, at least one of which is addressed to at least one of the plurality of management entities; and
sending the plurality of signals to the at least one of the plurality of management entities.

23. Apparatus comprising:
one or more system components, at least one of which is coupled to an antenna, wherein the antenna is to transmit and receive bus signals and to transmit and receive management signals; and
a management entity, further comprising a system-side antenna to send and receive management signals.

24. The apparatus of claim 23, further comprising:
a management network to receive a signal transmitted from a management-side antenna of the management entity.

25. The apparatus of claim 23, wherein the management entity is configured to analyze the received management signals and determine the relative health of the at least one system component.

26. The apparatus of claim 25, wherein the management entity is configured to send a management signal configured to alter at least one performance aspect of the at least one system component based on the determined relative health.

27. A system, comprising:
a plurality of system components, wherein at least one of the plurality of system components is coupled to an antenna;
a management entity, wherein the management entity further comprises a system-side antenna coupled to the management entity to receive wireless signals from the antenna of the at least one of the plurality of system components;
at least one omni-directional antenna communicatively coupled to the management entity.

28. The system of claim 27, further comprising:
a management network to receive a wireless signal transmitted from the at least one omni-directional antenna.

29. The apparatus of claim 28, wherein the management network is to analyze the received signal and transmit a signal configured to cause an alteration of at least one performance aspect of the at least one of the plurality of system components.
